(19) United States
(12) Patent Application Publication
(10) Pub. No.: US 2002/0195816 A1
(43) Pub. Date: Dec. 26, 2002

(54) Combined business card and brochure

(75) Inventor: Nader Anise, Pembroke Pines, FL (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Billicards, Inc.

(21) Appl. No.: 09/888,255

(22) Filed: Jun. 22, 2001

(51) Int. Cl. B42D 15/00

(52) U.S. Cl. 283/106

(57) ABSTRACT

An informational device, including a brochure having a plurality of panels, each panel having first and second opposing surfaces, adjacent pairs of panels being coupled at a fold line to permit folding of the brochure between an unfolded and a folded state, and a business card having first and second opposing surfaces, one of the first and second surfaces being coupled to and overlying a substantial portion of one of the first and second surfaces of one of the panels.

### BACKGROUND OF THE INVENTION

The present invention relates to a combined business card and brochure and, more particularly, to a folded unit that is substantially the size of a standard business card and that can be opened to reveal a brochure sheet from which a business card or the like can be viewed.

It is well known to provide a brochure to which a business card may be attached, e.g. by a staple adhesive backing on the business card, paper clip or other means, so that the viewer, after considering the product or services offered by the brochure, may contact the individual whose business card is attached to the brochure.

Paper clips may be awkward, and not esthetically pleasing for the presentation of the business card and brochure. Staples may also be awkward and present an obstacle to cleanly separating the business card from the brochure, often times tearing the brochure and/or business card. Attaching the card via an adhesive strip to the brochure likewise is less than desirable because the card may obscure some aspect of the brochure. In general, the unit is not compacted and is neither conveniently handled or stored and certainly cannot be placed in a pocket of the receiver for subsequent review in any convenient manner.

Accordingly, it would be desirable to provide a combination business card and brochure which is compact and can be conveniently carried in a pocket or wallet of an interested party for subsequent review, or in a pocket or holder of a sales person or manufacturer's representative for ready distribution and which will, at the same time, provide details of a product and service without size limitation and yet provide a business or visiting card of conventional size permitting subsequent contact.

### SUMMARY OF THE INVENTION

One aspect of the invention provides an informational device. The informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels.

Preferably, the plurality of panels of the brochure include at least first, second and third panels; the first and second panels are coupled at a first fold line so that the second panel is movable relative to the first panel about the first fold line; the second and third panels are coupled at a second fold line so that the third panel is movable relative to the second panel about the second fold line; and the first and second fold lines are substantially parallel to one another. More preferably, the device further includes a fourth panel, wherein the third and fourth panels are coupled at a third fold line so that the fourth panel is movable relative to the third panel about the third fold line, and the first, second and third fold lines are substantially parallel to one another. In a more preferred aspect of the invention, the device may further include a fifth panel, wherein the fourth and fifth panels are coupled at a fourth fold line so that the fifth panel is movable relative to the fourth panel about the fourth fold line, and the first, second, third and fourth fold lines are substantially parallel to one another.

In another aspect of the invention, the first surface of the business card includes indicia and the second surface of the business card is coupled to and overlying a substantial portion of one of the first and second surfaces of the first panel. In yet another aspect of the invention, the second surface of the business card is coupled to and overlying a substantial portion of one of the first and second surfaces of the second panel. In yet a further aspect of the invention, wherein the brochure includes fourth and fifth panels, the first surface of the business card includes indicia and the second surface of the business card is coupled to and overlying a substantial portion of one of the first and second surfaces of the first, second, third, fourth or fifth panels.

In another aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The plurality of panels of the brochure includes at least first, second and third panels; the first and second panels are coupled at a first fold line so that the second panel is movable relative to the first panel about the first fold line; the second and third panels are coupled at a second fold line so that the third panel is movable relative to the second panel about the second fold line; and the first and second fold lines are substantially transverse to one another. Preferably, the brochure includes a fourth panel, wherein the third and fourth panels are coupled at a third fold line so that the fourth panel is movable relative to the third panel about the third fold line, and the first, second and third fold lines are substantially transverse to one another. More preferably, the brochure includes a fifth panel, wherein the fourth and fifth panels are coupled at a fourth fold line so that the fifth panel is movable relative to the fourth panel about the fourth fold line, and the first, second, third and fourth fold lines are substantially transverse to one another.

In another aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The plurality of panels of the brochure includes at least first, second and third panels. The first and second panels are coupled at a first fold line so that the second panel is movable relative to the first panel about the first fold line. The second and third panels are coupled at a second fold line so that the third panel is movable relative to the second panel about the second fold line; and the first and second fold lines are substantially transverse to one another. The first surface of the business card includes indicia and the second surface of the business card is coupled to and overlying a substantial portion of one of the first and second surfaces of the first panel. In another aspect of the invention, the first surface of the business card includes indicia and the second surface of the business card is coupled to and overlying a substantial portion of one of the first and second surfaces of the second panel. In yet another aspect of the invention, wherein the brochure includes fourth and fifth panels, the first surface of the business card includes indicia and the second surface of the business card is coupled to and overlying a substantial portion of one of the first and second surfaces of the first, second, third, fourth or fifth panels.

In yet another aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The plurality of panels of the brochure include at least first, second and third panels. The first and second panels are coupled at a first fold line so that the second panel is movable relative to the first panel about the first fold line. The second and third panels are coupled at a second fold line so that the third panel is movable relative to the second panel about the second fold line. The first surface of the business card includes indicia and the second surface of the business card is coupled to and overlying a substantial portion of one of the first and second surfaces of the second panel.

In yet a further aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The plurality of panels of the brochure include at least first, second, third and fourth panels. The first and second panels are coupled at a first fold line so that the second panel is movable relative to the first panel about the first fold line. The second and third panels are coupled at a second fold line so that the third panel is movable relative to the second panel about the second fold line. The third and fourth panels are coupled at a third fold line so that the fourth panel is movable relative to the third panel about the third fold line. The first surface of the business card includes indicia and the second surface of the business card is coupled to and overlying a substantial portion of one of the first and second surfaces of the second or third panels.

In another aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The plurality of panels of the brochure include at least first, second, third, fourth and fifth panels; the first and second panels are coupled at a first fold line so that the second panel is movable relative to the first panel about the first fold line; the second and third panels are coupled at a second fold line so that the third panel is movable relative to the second panel about the second fold line; the third and fourth panels are coupled at a third fold line so that the fourth panel is movable relative to the third panel about the third fold line; the fourth and fifth panels are coupled at a fourth fold line so that the fifth panel is movable relative to the fourth panel about the fourth fold line; and the first surface of the business card includes indicia and the second surface of the business card is coupled to and overlying a substantial portion of one of the first and second surfaces of the second, third or fourth panels.

In another aspect of the invention, the fold lines of the brochure are substantially parallel in relation to one another.

In yet another aspect of the invention, the fold lines are substantially transverse in relation to one another.

In a further aspect of the invention, the informational device includes a brochure having a plurality of panels, each panel having first and second opposing surfaces, adjacent pairs of panels being coupled at a fold line to permit folding of the brochure between an unfolded and a folded state. The device also includes a business card having first and second opposing surfaces, one of the first and second surfaces being coupled to and overlying a substantial portion of one of the first and second surfaces of one of the panels. The business card further comprises a perimeter edge bounding a first area; the panels of the brochure in the folded state further comprise a combined perimeter edge bounding a second area; and the second area is not greater the first area. Preferably, the perimeter edge of the business card defines a first shape, the perimeter edge of the brochure in the folded state defines a second shape, and the first shape is substantially the same as the second shape.

In another aspect of the invention, the informational device includes a brochure having a plurality of panels, each panel having first and second opposing surfaces, adjacent pairs of panels being coupled at a fold line to permit folding of the brochure between an unfolded and a folded state. One of the panels of the brochure is coupled to an adjacent panel by perforations The device also includes a business card having first and second opposing surfaces, one of the first and second surfaces being coupled to and overlying a substantial portion of one of the first and second surfaces of one of the panels.

In another aspect of the invention, the informational device includes a brochure having a plurality of panels, each panel having first and second opposing surfaces, adjacent pairs of panels being coupled at a fold line to permit folding of the brochure between an unfolded and a folded state. One of the panels of the brochure includes a storage compartment. The device also includes a business card having first and second opposing surfaces, one of the first and second surfaces being coupled to and overlying a substantial portion of one of the first and second surfaces of one of the panels.

In yet a further aspect of the invention, the informational device includes a brochure having a plurality of panels, each panel having first and second opposing surfaces, adjacent pairs of panels being coupled at a fold line to permit folding of the brochure between an unfolded and a folded state. One of the panels of the brochure includes a note pad. The device also includes a business card having first and second opposing surfaces, one of the first and second surfaces being coupled to and overlying a substantial portion of one of the first and second surfaces of one of the panels.

Another aspect of the invention provides a method of presenting business information, which includes attaching a brochure having a plurality of panels, each panel having first and second opposing surfaces, adjacent pairs of panels being coupled at a fold line to permit folding of the brochure between an unfolded and a folded state, and a business card having first and second opposing surfaces, one of the first and second surfaces being coupled to and overlying a substantial portion of one of the first and second surfaces of one of the panels.

### BRIEF DESCRIPTION OF THE DRAWINGS

For the purpose of illustrating the invention, there are shown in the drawings forms that are presently preferred, it being understood, however, that the invention is not limited to the precise arrangements and instrumentalities shown.

FIG. 1 is a perspective view of an informational device in accordance with the present invention with the informational brochure in a unfolded state;

FIG. 2 is a perspective view of the informational device of FIG. 1 with the informational brochure in a folded state;

FIG. 3 is a perspective view of an alternate configuration for the informational device in accordance with one or more further aspects of the present invention;

FIG. 4 is a perspective view of an alternate configuration for the informational device in accordance with one or more further aspects of the present invention;

FIG. 5 is a perspective view of an alternate configuration for the informational device in accordance with one or more further aspects of the present invention;

FIG. 6 is a perspective view of an alternate configuration for the informational device in accordance with one or more further aspects of the present invention.

### DETAILED DESCRIPTION

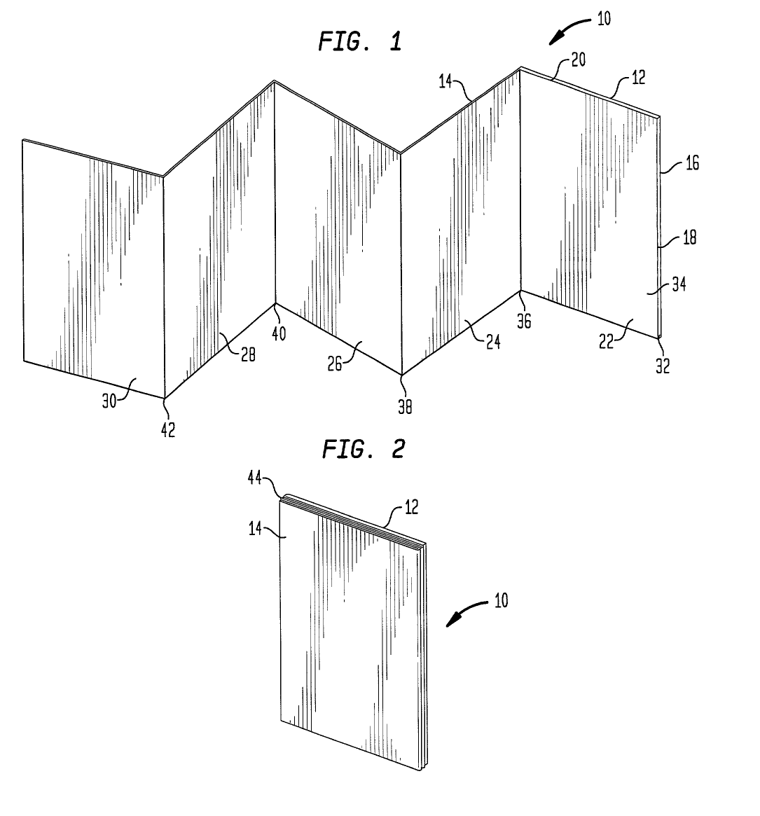

Referring now to the drawings, wherein like numerals indicate like elements, there is shown in FIG. 1 an informational device in accordance with one aspect of the present invention designated as 10. The informational device 10 preferably includes a conventional business card 12 to which an informational brochure 14 is attached.

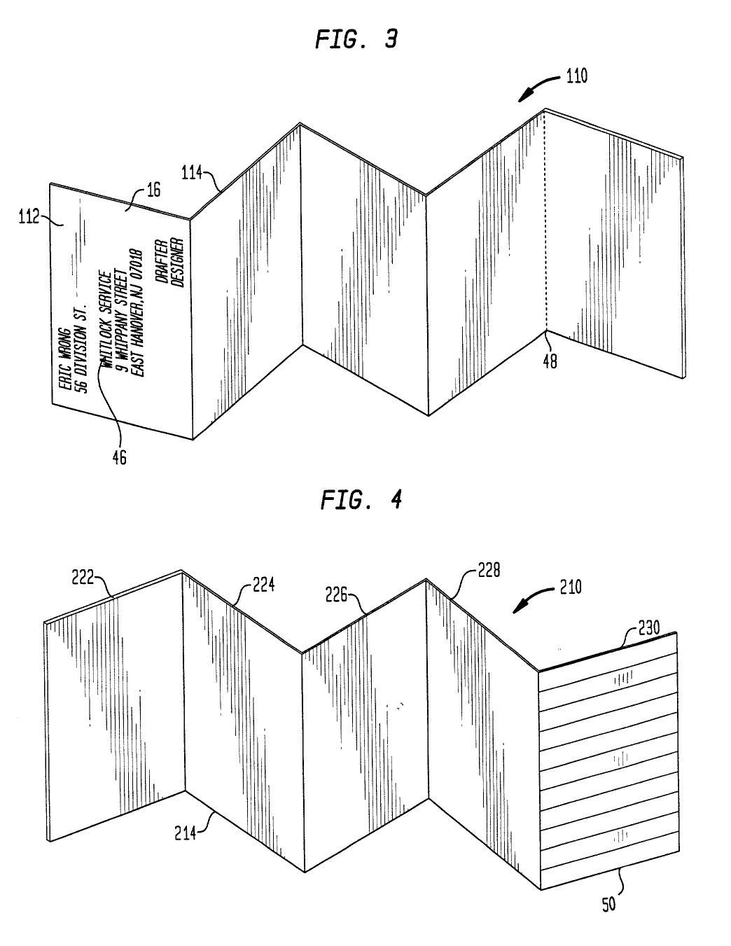

The business card 12 is a standard configuration business card, it being understood that, although preferred, a standard configuration business card is not necessary to practice the invention. The card 12 may have a conventional rectangular shape measuring approximately 3½inches by 2 inches. The business card 12 is substantially planar and has a first surface 16 and a second, oppositely facing surface 18. As shown in FIG. 3, the first surface 16 preferably has indicia 46 such as business information, placed thereon in a conventional manner. The business card further includes a perimeter edge 20 which bounds a first area. As shown in FIG. 4, the business card 12 may include indicia on one of the first or second surfaces 16, 18.

The informational brochure 14 may be a marketing sheet, advertising sheet or mini-billboard that may contain different information than the information that may be on the card 12. The brochure 14 consists of sheet material that takes folds at which it can be easily unfolded and refolded. It may be paper, or a paper-like material such as plastic sheets on which books are commonly printed, or it may be a very thin card or any other suitable flexible material. Preferably, the brochure 14 is of different paper stock than the card 12. It is conceivable that the sheet material may be stiff except at the folds, e.g. very thin cards interconnected by paper or cloth. The brochure 14 includes a first panel 22, a second panel 24 and a third panel 26. The panels of the brochure include a first surface 32 and a second, oppositely facing surface 34. The first and second panels 22, 24 are coupled at a first fold line 36 so that the second panel 24 is movable relative to the first panel 22 about the first fold line 36. The second and third panels 24, 26 are coupled at a second fold line 38 so that the third panel 26 is movable relative to the second panel 24 about the second fold line 38. Preferably, the first and second fold lines 36, 38 are substantially parallel to one another.

In a preferred aspect of the invention, the brochure includes a fourth panel 28, wherein the third and fourth panels 26, 28 are coupled at a third fold line 40 so that the fourth panel 28 is movable relative to the third panel 26 about the third fold line 40. Preferably, the first, second and third fold lines 36, 38, 40 are substantially parallel to one another.

In a more preferred aspect of the invention, the brochure further includes a fifth panel 30, wherein the fourth and fifth panels 28, 30 are coupled at a fourth fold line 42 so that the fifth panel 30 is movable relative to the fourth panel 28 about the fourth fold line 42. Preferably, the first, second, third and fourth fold lines 36, 38, 40, 42 are substantially parallel to one another. The fold lines 36, 38, 40, 42 allow the panels 22, 24, 26, 28, 30 to be moved relative to each other to allow the informational brochure 14 to be selectively placed in a folded state, as shown in FIG. 2, and an unfolded state, as found in FIG. 1. In the folded state, the brochure has a combined perimeter edge 44 which bounds a second area.

As shown in FIG. 1, the business card 12 is coupled to and overlays a substantial portion of one of the first and second surfaces 32, 34 of one of the panels of the brochure 14 by any conventional means. Preferably, the first surface 32 of the first panel 22 is affixed to the second surface 18 of the business card 12 so that the attached brochure does not interfere with or mask the first surface 16 of the business card, which may include indicia 46, as shown in FIG. 3. Preferably, the remaining panels of the brochure are coupled such that their respective fold lines are parallel to one another. In this configuration, the informational brochure 14 can be changed between the unfolded and folded states in a simple manner (achieving a compact size) that preferably does not project substantially outwardly from the perimeter edge 20 of business card 12. As shown in FIG. 2, in the folded state, the combined perimeter edge 44 of the brochure 14 is preferably not greater than the perimeter edge 20 of the business card 12. Preferably, the brochure 14 is attached such that the attached panel of the brochure 14 does not extend beyond the perimeter edge 20 of the business card 12.

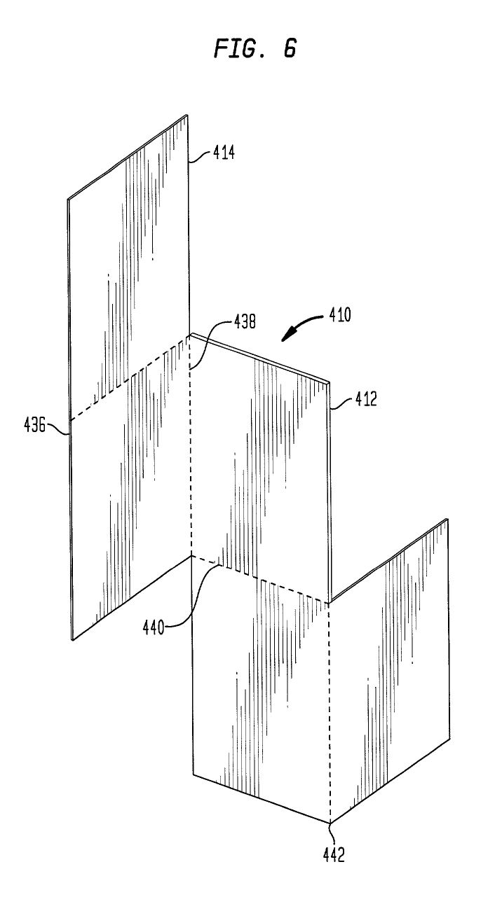

FIG. 6 illustrates another aspect of the invention wherein the brochure 414 includes fold lines 436, 438, 440, 442 that are not all parallel in relation to one another. Preferably, the first fold line 436 is transverse to fold line 438. Fold line 438 is transverse to fold line 440 and fold line 440 is transverse to fold line 442. Such a configuration permits the brochure 414 to be unfolded into various configurations while allowing it to be folded in a folded state such that the perimeter edge of the brochure does not extend substantially beyond the perimeter of the business card 412.

As shown in FIG. 3, one or more of the fold lines may include perforations 48 to allow the easy separation of the panel or panels from the rest of the brochure 114. Other separating means are also contemplated.

As depicted in FIG. 4, one or more of the panels 222, 224, 226, 228, 230 of brochure 214 may include a notepad 50 or similar structure to allow the user of the informational device 210 to add additional information to the brochure.

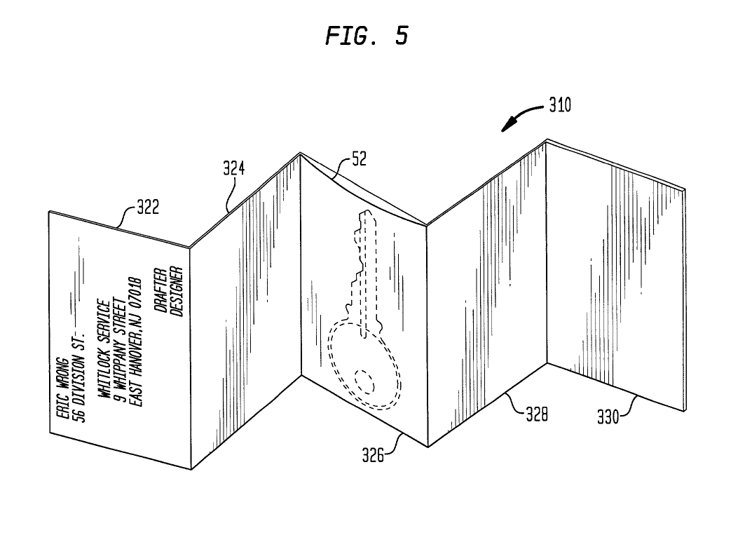

In yet another aspect of the invention, as shown in FIG. 5, one or more of the panels 322, 324, 326, 328, 330 of brochure 314 may include a storage compartment or pocket 52 to allow the user to store additional items, e.g. a key, coins, money, etc.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An informational device, comprising:
a brochure having a plurality of panels, each panel having first and second opposing surfaces, adjacent pairs of panels being coupled at a fold line to permit folding of the brochure between an unfolded and a folded state, and
a business card having first and second opposing surfaces, one of the first and second surfaces being coupled to and overlying a substantial portion of one of the first and second surfaces of one of the panels.

2. The informational device of claim 1, wherein:
the plurality of panels of the brochure include at least first, second and third panels;
the first and second panels are coupled at a first fold line so that the second panel is movable relative to the first panel about the first fold line;
the second and third panels are coupled at a second fold line so that the third panel is movable relative to the second panel about the second fold line; and
the first and second fold lines are substantially parallel to one another.

3. The informational device of claim 2, further including a fourth panel, wherein the third and fourth panels are coupled at a third fold line so that the fourth panel is movable relative to the third panel about the third fold line, and the first, second and third fold lines are substantially parallel to one another.

4. The informational device of claim 3, further including a fifth panel, wherein the fourth and fifth panels are coupled at a fourth fold line so that the fifth panel is movable relative to the fourth panel about the fourth fold line, and the first, second, third and fourth fold lines are substantially parallel to one another.

5. The informational device of claim 2, wherein the first surface of the business card includes indicia and the second surface of the business card is coupled to and overlying a substantial portion of one of the first and second surfaces of the first panel.

6. The informational device of claim 2, wherein the first surface of the business card includes indicia and the second surface of the business card is coupled to and overlying a substantial portion of one of the first and second surfaces of the second panel.

7. The informational device of claim 4, wherein the first surface of the business card includes indicia and the second surface of the business card is coupled to and overlying a substantial portion of one of the first and second surfaces of the first, second, third, fourth or fifth panels.

8. The informational device of claim 1, wherein:
the plurality of panels of the brochure include at least first, second and third panels;
the first and second panels are coupled at a first fold line so that the second panel is movable relative to the first panel about the first fold line;
the second and third panels are coupled at a second fold line so that the third panel is movable relative to the second panel about the second fold line; and
the first and second fold lines are substantially transverse to one another.

9. The informational device of claim 8, further including a fourth panel, wherein the third and fourth panels are coupled at a third fold line so that the fourth panel is movable relative to the third panel about the third fold line, and the first, second and third fold lines are substantially transverse to one another.

10. The informational device of claim 9, further including a fifth panel, wherein the fourth and fifth panels are coupled at a fourth fold line so that the fifth panel is movable relative to the fourth panel about the fourth fold line, and the first, second, third and fourth fold lines are substantially transverse to one another.

11. The informational device of claim 8, wherein the first surface of the business card includes indicia and the second surface of the business card is coupled to and overlying a substantial portion of one of the first and second surfaces of the first panel.

12. The informational device of claim 8, wherein the first surface of the business card includes indicia and the second surface of the business card is coupled to and overlying a substantial portion of one of the first and second surfaces of the second panel.

13. The informational device of claim 10, wherein the first surface of the business card includes indicia and the second surface of the business card is coupled to and overlying a substantial portion of one of the first and second surfaces of the first, second, third, fourth or fifth panels.

14. The informational device of claim 1, wherein:
the plurality of panels of the brochure include at least first, second and third panels;
the first and second panels are coupled at a first fold line so that the second panel is movable relative to the first panel about the first fold line;
the second and third panels are coupled at a second fold line so that the third panel is movable relative to the second panel about the second fold line; and
the first surface of the business card includes indicia and the second surface of the business card is coupled to and overlying a substantial portion of one of the first and second surfaces of the second panel.

15. The informational device of claim 1, wherein:
the plurality of panels of the brochure include at least first, second, third and fourth panels;
the first and second panels are coupled at a first fold line so that the second panel is movable relative to the first panel about the first fold line;
the second and third panels are coupled at a second fold line so that the third panel is movable relative to the second panel about the second fold line;
the third and fourth panels are coupled at a third fold line so that the fourth panel is movable relative to the third panel about the third fold line; and
the first surface of the business card includes indicia and the second surface of the business card is coupled to and overlying a substantial portion of one of the first and second surfaces of the second or third panels.

16. The informational device of claim 1, wherein:
the plurality of panels of the brochure include at least first, second, third, fourth and fifth panels;
the first and second panels are coupled at a first fold line so that the second panel is movable relative to the first panel about the first fold line;
the second and third panels are coupled at a second fold line so that the third panel is movable relative to the second panel about the second fold line;
the third and fourth panels are coupled at a third fold line so that the fourth panel is movable relative to the third panel about the third fold line;
the fourth and fifth panels are coupled at a fourth fold line so that the fifth panel is movable relative to the fourth panel about the fourth fold line; and
the first surface of the business card includes indicia and the second surface of the business card is coupled to and overlying a substantial portion of one of the first and second surfaces of the second, third or fourth panels.

17. The informational device of claims 14, 15 or 16, wherein the fold lines are substantially parallel in relation to one another.

18. The informational device of claim 14, 15 or 16, wherein the fold lines are substantially transverse in relation to one another.

19. The informational device of claim 1, wherein:
the business card further comprises a perimeter edge bounding a first area;
the panels of the brochure in the folded state further comprise a combined perimeter edge bounding a second area; and
the second area is not greater the first area.

20. The informational device of claim 19, wherein the perimeter edge of the business card defines a first shape, the perimeter edge of the brochure in the folded state defines a second shape, and the first shape is substantially the same as the second shape.

21. The informational device of claim 1, wherein one of the panels of the brochure is coupled to an adjacent panel by perforations.

22. The informational device of claim 1, wherein one of the panels of the brochure includes a storage compartment.

23. the informational device of claim 1, wherein one of the panels of the brochure includes a note pad.

24. A method of presenting business information, comprising:
attaching a brochure having a plurality of panels, each panel having first and second opposing surfaces, adjacent pairs of panels being coupled at a fold line to permit folding of the brochure between an unfolded and a folded state, and a business card having first and second opposing surfaces, one of the first and second surfaces being coupled to and overlying a substantial portion of one of the first and second surfaces of one of the panels.
